(19) United States
(12) Patent Application Publication
(10) Pub. No.: US 2015/0266700 A1
(43) Pub. Date: Sep. 24, 2015

(54) CALL-GIVING SYSTEM OF AN ELEVATOR AND METHOD FOR GIVING ELEVATOR CALLS IN THE CALL-GIVING SYSTEM OF AN ELEVATOR

(71) Applicant: Jukka SALMIKUUKKA, Espoo (FI)

(72) Inventor: Jukka SALMIKUUKKA, Espoo (FI)

(73) Assignee: KONE CORPORATION, Helsinki (FI)

(21) Appl. No.: 14/734,265

(22) Filed: Jun. 9, 2015

Related U.S. Application Data
(63) Continuation of application No. PCT/FI2014/050012, filed on Jan. 8, 2014.

(30) Foreign Application Priority Data
Jan. 8, 2013 (FI) 20135023

(51) Int. Cl. B66B 1/34; B66B 1/46

(52) U.S. Cl. CPC B66B 1/3492; B66B 1/468

(57) ABSTRACT

The call-giving system of an elevator comprises at least one optical sensor and/or a microwave sensor, which is/are configured to give a signal to the call system of the elevator about an object or shape coming into one or more virtual target areas defined in the detection area. The patent application also comprises an independent claim for a method for giving elevator calls in the call-giving system of an elevator.

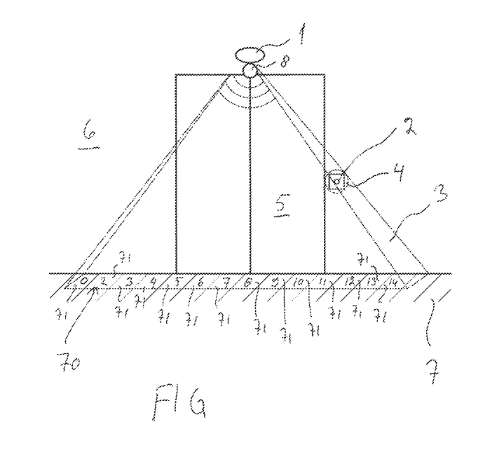

This application is a continuation of PCT International Application No. PCT/FI2014/050012 which has an International filing date of Jan. 8, 2014, and which claims priority to Finnish patent application number 20135023 filed Jan. 8, 2013, the entire contents of both of which are incorporated herein by reference.

### FIELD OF THE INVENTION

The invention relates to call-giving systems of elevators.

### TECHNICAL BACKGROUND

Elevator calls are generally given by pressing call-giving buttons. Often in a lobby or on a floor level there is a button or buttons with which an elevator call is given. By pressing one button, a call “elevator come here” is given. By pressing one of two buttons a call “user wants to go up” or “user wants to go down” is given. The actual choice of floor is not possible in this case for the user to implement until after stepping into the elevator car.

In new elevators, primarily in those intended for high-rise buildings, a destination operating panel (DOP) is nowadays increasingly more often in use. In this case when giving an elevator call the user declares to which floor he/she is going. Since the destination operating panel in locations having multiple elevators gives as a response which elevator the user must step into, this enables more efficient use of the elevators since e.g. a full elevator is driven past waiting floor levels that have passengers waiting for an elevator but intending to travel only a short distance, in which case the elevator can be driven at a higher speed. Passengers intending to travel only a short distance are then served with emptier and/or slower-moving elevators.

Call-giving buttons and a destination operating panel require electrical installations in the lobby and on the floors of buildings, with which installations an elevator is called. This increases the costs of elevator installations. In addition, call-giving buttons and a destination operating panel typically generate technical servicing work and require e.g. regularly wiping clean for reasons of hygiene and tidiness.

### Aim of the Invention

The aim of the invention is to reduce the amount of electrical installations needed in the lobbies and on the floors of buildings in connection with elevator installations.

This aim can be resolved with a call-giving system of an elevator, as defined in the independent claim 1, and with the method for giving elevator calls in the call-giving system of an elevator, as defined in the parallel independent claim 12.

The dependent claims describe some inventive and preferred embodiments of the call-giving system of an elevator.

### Advantages of the Invention

When a call-giving system of an elevator comprises at least one optical sensor and/or a microwave sensor, which is/are configured to give a signal to the call system of the elevator about an object or shape coming into one or more virtual target areas defined in the detection area, the amount of electrical installations needed in the lobbies and on the floors of buildings can be reduced, because the call-giving buttons or call-giving panel can be left uninstalled. Alternatively, or in addition to this, one advantage to be achieved is that since virtual target areas implemented by the aid of an optical sensor and/or a microwave sensor for their part at least reduce the use of call-giving buttons or a call-giving panel, the need for cleaning these can be reduced.

When the call system of an elevator is configured to process a signal coming from an optical sensor and/or from a microwave sensor into the one or more virtual target areas as an elevator call, the dirt accretion resulting from use of call-giving buttons or of a call-giving panel can be prevented even better.

When an optical sensor and/or the microwave sensor and the one or more virtual target areas defined in it/them is arranged to replace a conventional call button assembly or destination operating panels used in an elevator, or to supplement it, at least some of the call-giving buttons or call-giving panels can be omitted, which simplifies the installations needed and enables reduction of the amount of components.

According to a preferred embodiment of the call-giving system, a target area is configured to cause a landing call. This type of call-giving system can be implemented so as to be very easy to use.

According to a second preferred embodiment of the call-giving system, in the call-giving system an own target area is arranged for each respective floor in a plurality of elevator floors. This enables the giving of a destination floor already in connection with ordering an elevator and thus speeds up elevator travel by shortening the stop needed. In addition, the use of the elevators can be optimized in the manner described in the “Technical background” section above without a DOP system that is vulnerable to vandalism. In this case according to a preferred aspect the target areas are areas visibly marked in a lobby and/or on a floor.

When the call-giving system of an elevator additionally comprises at least one loudspeaker for indicating the selection of each respective, or the selected, virtual target area with a sound signal, it is possible, in particular with regard to children, elderly people and people with poor eyesight (including the visually impaired), but also with regard to other users, to facilitate use of the elevator when there is acoustic feedback about the selection of a target area. When an own target area for each respective floor is additionally arranged in the call-giving system, according to the preceding paragraph, the call-giving system can be configured, according to a preferred embodiment, to give via a loudspeaker a sound signal according to the floor according to each respective target area, e.g. the number, name or identifier of the selected floor is notified acoustically. In this case the user is able to notice immediately whether the call-giving system has selected the correct floor.

Since the call-giving system of the elevator comprises optical sensors and/or microwave sensors installed on different floors of the building, for each respective sensor of which sensors one or more virtual target areas are defined, and which sensors are linked to a centralized call-giving system of the elevator for centrally controlling the functionalities of the optical sensors and/or microwave sensors, the maintenance of the building is significantly facilitated.

According to a preferred embodiment an optical sensor is, or comprises, one or more of the following: a laser radar, a laser scanner, and/or an infrared sensor provided with background measuring. The microwave sensor is most preferably a microwave-Doppler radar.

According to one preferred embodiment the optical sensor and/or microwave sensor is configured to receive its operating energy from the electrical system of the elevator. Thus the amount of electrical lines that need to be laid in a building in the lobbies and on the floors can be significantly reduced.

In the method for giving elevator calls in the call-giving system of an elevator, virtual pushbuttons are used for giving floor calls and/or landing calls to the call-giving system of the elevator, which virtual pushbuttons are implemented as a detection area of an optical sensor and/or of a microwave sensor and/or as one or more virtual target areas.

### DETAILED DESCRIPTION

According to the only drawing FIG, points, an area or areas 4, 70, 71 are defined in an area 3 to be observed by a laser radar 1, in which points or area(s) an event detected by the laser radar 1, e.g. the bringing of a hand, foot or stick into the area 4, 70, 71 generates an additional function or additional functions. For example, when a hand is brought into a defined point or area 4 at the side of the door 5 of the elevator, an elevator landing call is generated automatically.

An area is defined in the logic comprised in a laser radar 1, which area generates an additional function when the laser radar 1 locates something brought into a defined point, area or areas 4, 70, 71.

B.E.A. SA (see in more detail on the Internet at www.bea-industrial.be and www.sensorio.be) offers laser radars possibly suited to the application. In addition to, or instead of, a laser radar 1, some other optical sensor, more particularly a laser scanner, an infrared detector provided with background measuring or a microwave-Doppler radar, can be used. B.E.A. SA's products LZR(R)-i110 (laser scanner), IRIS OFF INDUS (infrared detector provided with background measuring) and MAGIC SWITCH (microwave-Doppler radar) are devices possibly suited to the application.

In the following some embodiments of the call-giving system and of the method are given by the aid of a laser radar 1, but in addition to, or as an alternative to, a laser radar one or more of the optical sensors presented in the preceding paragraph can be used here.

### Embodiment 1

A laser radar 1 is integrated into the elevator, primarily for the curtain-of-light function for increasing safety. The laser radar 1 covers the defined area 3. The landing call button generally used in elevators is replaced with a stick 2 or with some other identifier, which tells where the landing call-giving device is. When a hand, stick or foot is brought into the area 4 defined for the laser radar 1, a landing call of the elevator is generated by the action of an input transmitted by the laser radar 1.

### Embodiment 2

A landing call is generated when a user steps into a certain defined part 70 in an elevator lobby 6, said part being in an area 3 covered by the laser radar 1.

In addition to this, or alternatively, if own points or boxes 71 are defined for each of the respective various floor calls (for each floor 0, 2, 3, 4, 5, 6, 7, 8, 9, 10, 11, 12, 13, 14 of the building reachable with an elevator, an own separate box 71 is selected), instead of, or in addition to, a landing call also a floor call to defined floors can be automatically generated, so long as it is sufficiently clearly indicated to a user in which point or box 71 of the lobby or waiting landing a call to which floor will be generated.

Indication is preferably implemented with a marking made on the floor 7. In addition to this, or alternatively, the marking can be reflected or projected onto the floor.

### Embodiment 3

Use of a call-giving device, e.g. a call button assembly or destination operating panel, e.g. in the case of a visually impaired user: the user takes his/her hand, stick or foot into the defined point or area 4, 70, 71 in connection with the operating area of the call-giving device and laser radar 1. The user is guided e.g. with voice control in such a way that the voice control states the floor numbers in sequence and when the floor wanted by the user is said, he/she pulls his/her hand, stick or foot away from the point or area 4, 70, 71 defined for the laser radar 1, which locks the selected floor and a call is generated. The acoustic signal needed for voice control is reproduced preferably via a loudspeaker 8.

### Embodiment 4

There can be a number of different laser radars 1 in a building, which radars are linked to one back-end system, via which the additional functionalities of the laser radars 1 can be centrally programmed.

Physical ancillary devices, e.g. landing call buttons, can be replaced with the call-giving system of an elevator and with the method, which enables savings in component costs. In this way the amount of different electricity-consuming devices can be reduced and thus the energy consumption of the whole call-giving system can be reduced.

The management invented facilitates the maintenance of the building.

In embodiments 2 and 3 the user can be offered a better user experience.

The invention must not be regarded as being limited only to the claims below but instead should be understood to include all legal equivalents of said claims.

1. Call-giving system of an elevator, which comprises at least one optical sensor and/or a microwave sensor, which is/are configured to give a signal to the call system of the elevator about an object or shape coming into one or more virtual target areas defined in the detection area, and in which the call system of the elevator is configured to process a signal coming from an optical sensor and/or from a microwave sensor into the one or more virtual target areas as an elevator call, wherein the optical sensor and/or the microwave sensor and the one or more virtual target areas defined in it/them is arranged to replace a conventional call button assembly or destination operating panel used in an elevator or to supplement it.

2. Call-giving system of an elevator according to claim 1, wherein the target area is configured to cause a landing call.

3. Call-giving system of an elevator according to claim 1, wherein an own target area is arranged for each respective floor in a plurality of elevator floors.

4. Call-giving system of an elevator according to claim 3, wherein the target areas are areas visibly marked in a lobby and/or on the floor.

5. Call-giving system of an elevator according to claim 1, which additionally comprises at least one loudspeaker for indicating the selection of each respective, or the selected, virtual target area with a sound signal.

6. Call-giving system of an elevator according to claim 5, which is configured to give via a loudspeaker a sound signal according to the floor according to each respective target area.

7. Call-giving system of an elevator according to claim 1, which comprises optical sensors installed on different floors of the building, for each respective sensor of which sensors one or more virtual target areas are defined, and which sensors are linked to a centralized call-giving system of the elevator for centrally controlling the functionalities of optical radars.

8. Call-giving system of an elevator according to claim 1, wherein an optical sensor is, or comprises, one or more of the following: a laser radar, a laser scanner, an infrared sensor provided with background measuring, and/or the microwave sensor is a microwave-Doppler radar.

9. Call-giving system according to claim 1, wherein the optical sensor and/or microwave sensor is configured to receive its operating energy from the electrical system of the elevator.

10. Method for giving elevator calls in a call-giving system of an elevator, wherein virtual pushbuttons are used for giving floor calls and/or landing calls to the call-giving system of an elevator, which virtual pushbuttons are implemented as a detection area of an optical sensor and/or microwave sensor and/or as one or more virtual target areas.
